(19) United States
(12) Patent Application Publication
(10) Pub. No.: US 2018/0345599 A1
(43) Pub. Date: Dec. 6, 2018

(54) NODE WITH CO-PRINTED LOCATING FEATURES AND METHODS FOR PRODUCING SAME

(71) Applicant: DIVERGENT TECHNOLOGIES, INC., Los Angeles, CA (US)

(72) Inventors: John Russell Bucknell, El Segundo, CA (US); Kevin Robert Czinger, Santa Monica, CA (US); Antonio Bernerd Martinez, El Segundo, CA (US); Broc William TenHouten, Rancho Palos Verdes, CA (US); Eahab Nagi El Naga, Topanga, CA (US); David Brian TenHouten, Los Angeles, CA (US); Thomas Samuel Bowden, JR., Los Angeles, CA (US)

(21) Appl. No.: 15/613,036

(22) Filed: Jun. 2, 2017

(51) Int. Cl. B29C 67/00; B29C 65/54; B33Y 10/00; B33Y 80/00

(52) U.S. Cl. CPC B29C 67/0059; B33Y 80/00; B33Y 10/00; B29C 65/542

(57) ABSTRACT

Some embodiments of the present disclosure relate to an apparatus including an additively manufactured node having a socket. The apparatus includes one or more locating features co-printed with the node. The one or more locating features are configured to locate an end portion of a component in the socket.

### BACKGROUND

### Field

The present disclosure relates generally to techniques for co-printing locating features with a node, and more specifically to additively manufacturing nodes with co-printed locating features to locate an edge of a component accurately within a node socket.

### Background

Additive Manufacturing (AM) processes involve the layer-by-layer buildup of one or more materials to make a 3-dimensional object. AM techniques are capable of fabricating complex components from a wide variety of materials. Typically, a freestanding object is fabricated from a computer aided design (CAD) model. Using the CAD model, the AM process can create a solid 3-dimensional object by using a laser beam to sinter or melt a powder material, which then bonds the powder particles together. In the AM process, different materials or combinations of material, such as engineering plastics, thermoplastic elastomers, metals, and ceramics may be used to create a uniquely shaped 3-dimensional object.

Several different printing techniques exist. One such technique is called selective laser melting. Selective laser melting entails fusing (agglomerating) particles of a powder at a temperature below the melting point of the powder material. More specifically, a laser scans a powder bed and melts the powder together where structure is desired, and avoids scanning areas where the sliced data indicates that nothing is to be printed. This process may be repeated thousands of times until the desired structure is formed, after which the printed part is removed from a fabricator.

As AM processes continue to improve, more complex mechanical manufacturers are beginning to investigate the benefits of using additively manufactured parts in their designs. This is because the automotive industry, aircraft manufacturing, and other industries involved in the assembly of transport structures are constantly engaging in cost saving optimizations and looking for opportunities to improve manufacturing processes by reducing the number of parts that are wasted due to variations that may occur in manufacturing. Joining components that may exhibit minor variations in size is one such area that has proven difficult to overcome. For instance, conventional manufacturing processes provide simple internal designs configured to closely fit around and seal a component in place. However, such structures are limiting in that manufactured components that may be slightly thicker, for example, may be too large and consequently wasted. Each wasted part adds to the manufacturing cost of the product and due to the inflexibility of the conventionally manufactured designs, a significant amount of waste can occur. This phenomenon drives up the manufacturing cost, which is often passed onto the consumer. The attendant raising of consumer costs can, in turn, be problematic because the high price tag often associated with complex products alienates a significant number of consumers. Thus, there is a need to reduce the amount of waste associated with joining one or more additively manufactured components.

Fortunately, the recent advances in 3-dimensional printing or AM processes have presented new opportunities to incorporate simple internal features that were not previously available under conventional manufacturing techniques. With AM, components with unique internal structures may be printed which may provide greater flexibility when joining components. However, a new set of challenges emerges with the availability of parts having more flexibility. For instance, a socket designed to fit a larger variety of sizes may make it difficult to correctly position a smaller component in a larger socket because the component may move about a larger space.

### SUMMARY

Several aspects of techniques for joining an additively manufactured node to a component will be described more fully hereinafter with reference to 3-dimensional printing techniques.

One aspect of an apparatus includes an additively manufactured node having a socket. The apparatus includes one or more locating features co-printed with the node. The one or more locating features are configured to locate an end portion of a component in the socket.

One aspect of a method includes printing, by additive manufacturing, a node having a socket. The method co-prints, with the node, one or more locating features. The one or more locating features are configured to locate an end portion of a component in the socket.

It will be understood that other aspects of co-printing locating features with additively manufactured nodes will become readily apparent to those skilled in the art from the following detailed description, wherein it is shown and described only several embodiments by way of illustration. As will be realized by those skilled in the art, the co-printing of interconnects with additively manufactured nodes are capable of other and different embodiments and its several details are capable of modification in various other respects, all without departing from the invention. Accordingly, the drawings and detailed description are to be regarded as illustrative in nature and not as restrictive.

### BRIEF DESCRIPTION OF THE DRAWINGS

Various aspects of co-printing interconnects with additively manufactured nodes will now be presented in the detailed description by way of example, and not by way of limitation, in the accompanying drawings, wherein:

FIG. 1 illustrates an exemplary embodiment of an apparatus comprising a node and a co-printed locating feature.

FIG. 2 illustrates another exemplary embodiment of an apparatus comprising a node and co-printed locating feature.

FIGS. 3A-3B illustrate an exemplary embodiment an apparatus having a node with a co-printed locating feature for joining a panel to the node.

FIG. 4 illustrates an alternative embodiment of the apparatus in FIG. 3 where the locating features are bumps.

FIG. 5 illustrates an exemplary embodiment of an apparatus having a node with co-printed shims.

FIG. 6 illustrates an exemplary embodiment of an apparatus having a node having an oversized socket and a co-printed nozzle.

FIG. 7 illustrates an exemplary embodiment of an apparatus having a node and co-printed strut.

FIG. 8 illustrates an exemplary embodiment of an apparatus having a node and a co-printed bump.

FIG. 9 illustrates an exemplary embodiment of an apparatus having a node with co-printed projections.

FIG. 10 illustrates an exemplary embodiment of an apparatus 1000 having a node having co-printed projections and secondary shim.

FIG. 11 illustrates an exemplary embodiment of an apparatus having a converging socket locator.

FIG. 12 conceptually illustrates a process for co-printing a node with locating features.

### DETAILED DESCRIPTION

The detailed description set forth below in connection with the appended drawings is intended to provide a description of various exemplary embodiments of additively manufacturing techniques for co-printing nodes and interconnects and is not intended to represent the only embodiments in which the invention may be practiced. The term “exemplary” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the invention to those skilled in the art. However, the invention may be practiced without these specific details. In some instances, well-known structures and components may be shown in block diagram form, or omitted entirely, in order to avoid obscuring the various concepts presented throughout this disclosure.

The use of additive manufacturing in the context of co-printing nodes and interconnects provides significant flexibility and cost saving benefits that enable manufacturers of mechanical structures and mechanized assemblies to manufacture parts with complex geometries at a lower cost to the consumer. The joining techniques described in the foregoing relate to a process for joining additively manufactured parts and/or commercial of the shelf (COTS) components such as panels. Additively manufactured parts are 3-dimensionally printed by adding layer upon layer of a material based on a preprogramed design. The parts described in the foregoing may be parts used to assemble a motor vehicle such as an automobile. However, those skilled in the art will appreciate that the manufactured parts may be used to assemble other complex mechanical products such as vehicles, trucks, trains, motorcycles, boats, aircraft, and the like without departing from the scope of the invention.

One important issue that has been encountered in these industries is how to enable various disparate parts or structures to more effectively interconnect. One such technique as disclosed herein involves the use of additive manufacturing. More specifically, by utilizing additive manufacturing techniques to print locating features, it becomes simpler to join different parts and/or components in the manufacturing process while also providing a flexible design to account for manufacturing variations. Such variations may occur, for example, due to variability in environmental conditions and material during the printing and subsequent manufacturing (e.g., joining). Such techniques can include printing larger sockets with flexible locating features capable of holding, adjusting to the size of, and locating a component in the socket. Additive manufacturing provides the ability to produce nodes with these internal locating features, which was not previously possible using conventional manufacturing techniques. As a result, waste resulting from less effective techniques may be eliminated.

As will be discussed herein, a node is an example of an additively manufactured part. A node may be any 3-D printed part that includes a socket for accepting a component such as a tube and/or a panel. The node may have internal features configured to accept a particular type of component. Alternatively or conjunctively, the node may be shaped to accept a particular type of component. A node, in some embodiments of this disclosure may have internal features for positioning a component in the node's socket. However, as a person having ordinary skill in the art will appreciate, a node may utilize any internal design or shape and accept any variety of components without departing from the scope of the disclosure.

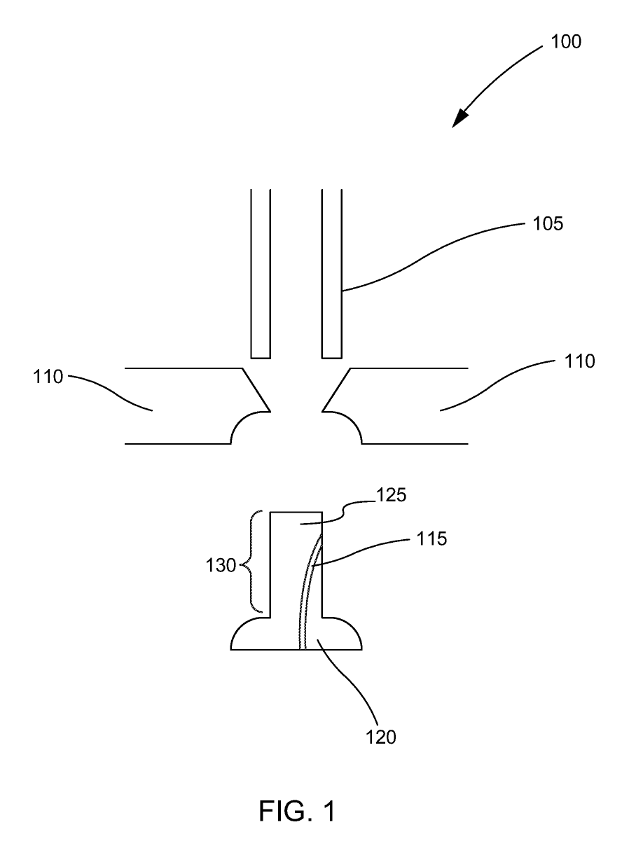

FIG. 1 illustrates an exemplary embodiment of an apparatus 100 comprising a node and a co-printed locating feature. As shown, the apparatus 100 includes a node 120, a component 105, end caps 110, and an adhesive port 115. The node 120 also includes a locating feature 130. In some aspects of the apparatus, the component 105 is a tube.

When assembled, the end caps 110 fit around the lower protrusions of the node 120 to form a socket. The locating feature 130 of the node 120 locates the lower, end portion of the component 105 around the locating feature 130 and between the end caps 110, such that the component 105 fits within the socket formed by the end caps 110 and the node 120. Once the component is placed in the socket, adhesive may be injected through the adhesive port 115 to fix the component 105 to the node 120. The adhesive may then be cured by applying heat to the apparatus 100.

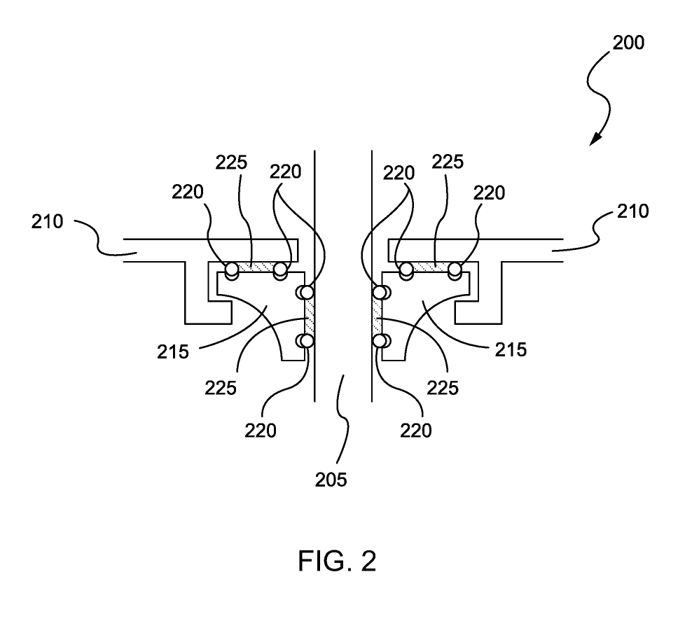

FIG. 2 illustrates another exemplary embodiment of an apparatus 200 comprising a node and co-printed locating feature. The apparatus 200 includes a component 205, a node 210, locating feature 215, screws 220, and an adhesive 225. In some aspects of the apparatus, the locating feature 215 is co-printed with the node 210. In some aspects of the apparatus, the component 205 is a tube.

As shown, the locating feature 215, in combination with the node 210, allows the component 205 to have vertical and some lateral movement. By providing two degrees of movement, greater flexibility is achieved when joining the node with the component. For instance, temperature differences between the time the node and locating feature are printed and the time they are joined with the component 205 may cause the component 205 to expand or contract in size. The design illustrated in FIG. 2 can accommodate any size changes by enabling the component 205 to move laterally within the locating feature 215 and the node 210. The end of the node 210 nearest the component 205 may create a socket. The locating feature 215 may locate an end portion of the component 205 in the socket.

Once the component is positioned appropriately, the adhesive 225 may be applied between the locating feature 215 and the component 205 as well as between the locating feature 215 and the node 210. Alternatively or conjunctively, screws 220 may also be applied to the locating feature 215 to hold the component 205 and the node 210 in place.

While the above description relates primarily to using locating features to join a tube and a node, the techniques described in this disclosure are not only applicable to tubes. In fact, any suitable component that may be bonded to a node may be joined to a node without departing from the scope of the disclosure. For instance, as will be discussed in the foregoing sections, locating features may be appropriate to accurately join a panel and a node.

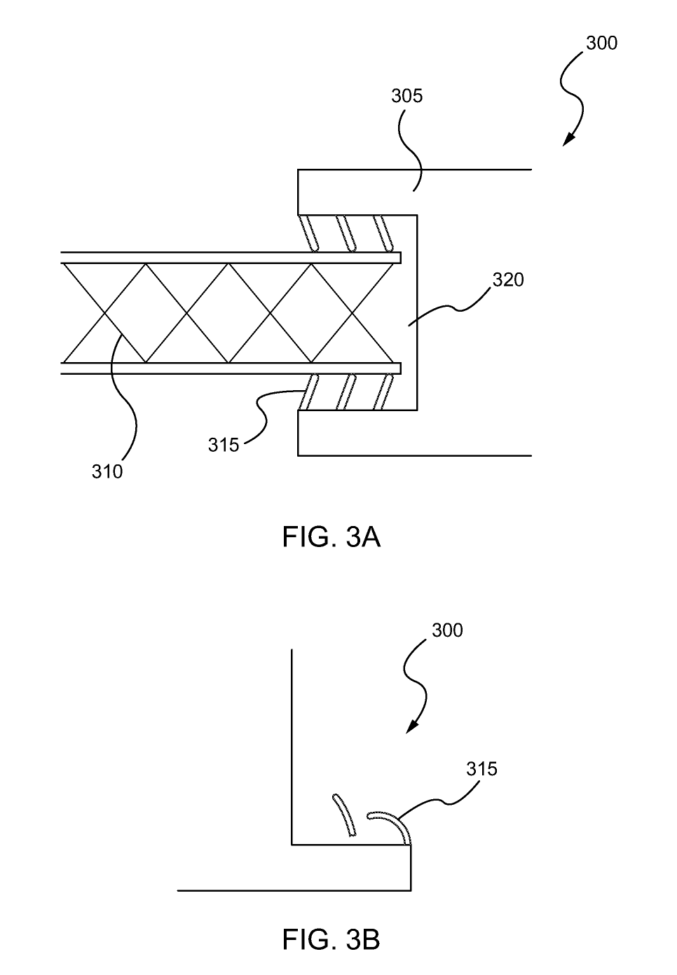

FIG. 3A illustrates an exemplary embodiment an apparatus 300 having a node with a co-printed locating feature for joining a panel to the node. The apparatus 300 includes a node 305 and a component 310. The node 305 may include a socket 320 and locating features 315. In this exemplary figure, the locating features 315 may be a deformable and/or detachable barb. In some aspects of the apparatus, the component 310 may be a panel.

As shown, the panel 310 may slide through the deformable barbs 315. The deformable barbs 315 guide the component 310 by locating the end portion of the component 310 in the socket 320. As the component 310 slides along the barbs 315, each barb 315 may bend to accommodate the panel 310, while also providing enough force to hold the component 310 in place. Once the component 310 is placed correctly, an adhesive may be injected into the socket 320 to fix the component 310 into place within the socket 320.

FIG. 3B illustrates an expanded view of a few of the barbs 315 from the apparatus 300. As shown, the barb 315 may be of a variety of shapes and sizes so long as the barb 315 is capable of sufficiently deforming and providing the appropriate level of force to hold and locate the component 310 in place. Moreover, the barb 315 may also be detachable, as shown in FIG. 3B. The barbs 315 may be detached before or while curing the adhesive in the socket 320. In some aspects of the apparatus, the barbs 315 may be made of plastic.

Such designs accommodate manufacturing variabilities that may occur due to environmental variables. The barbs 315 are able to both mechanically lock the component 310 and to control the gap size of the 320. As a result, in some instances the node 305 and component 310 may be adequately joined without the use of any adhesive. In such instances, the barbs 315 may not be removed.

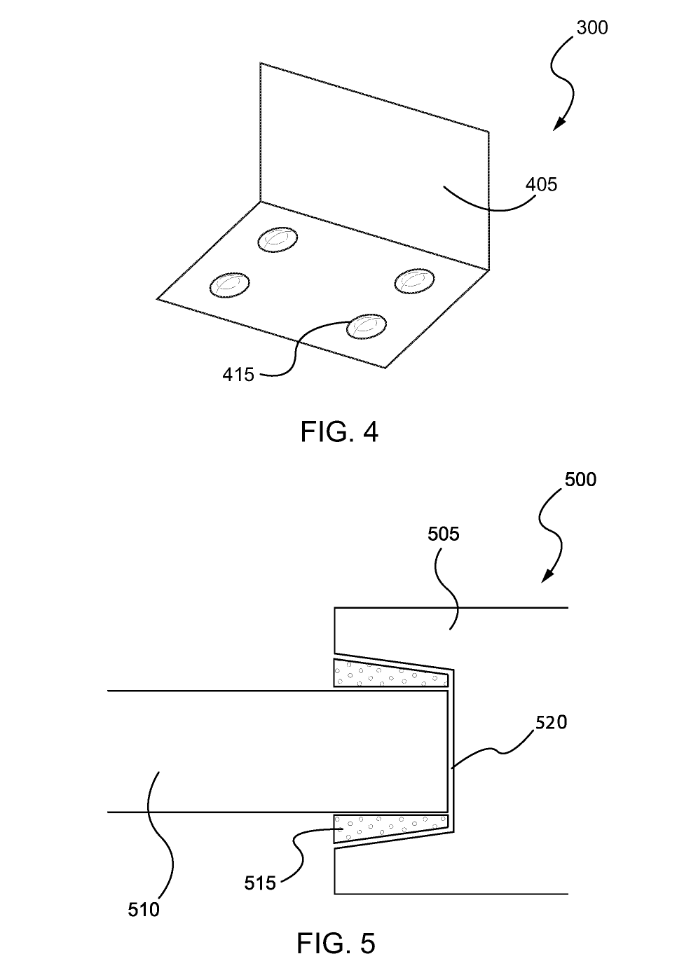

FIG. 4 illustrates an alternative embodiment of the apparatus 300 where the locating features are bumps. As shown, the apparatus 300 includes the node 405 and bumps 415. The bumps may replace the barbs 315 and similarly locate an end portion of the component 310 in the socket of the node 405. Once in place, the bumps 415 may be spot welded to join the node with the panel.

FIG. 5 illustrates an exemplary embodiment of an apparatus 500 having a node 505 with co-printed shims. The apparatus 500 includes a node 505 and a component 510. The node 505 includes tapered shims 515 and a socket 520.

The tapered shims 515 may be co-printed with the node 505 and used to locate the component 510 in the socket. In some aspects such a design allows for the generation of sockets of a variety of shapes and sizes. For instance, FIG. 5 illustrates a near-conical shaped socket 520. In some aspects of the apparatus, an adhesive may be injected into the socket 520 to fix the node 505 to the panel 510. In such aspects, the co-printed shims 515 may have swiss cheese-like holes cut into the shims, which creates passages through which an injected adhesive can travel during adhesion. The apparatus 500 may then be heated to cure the adhesive in the socket 520.

This design also accounts for variabilities in manufacturing because the shims may be co-printed in numerous different shapes and conform to the shape of an inserted panel or other suitable component that may be bonded to a node.

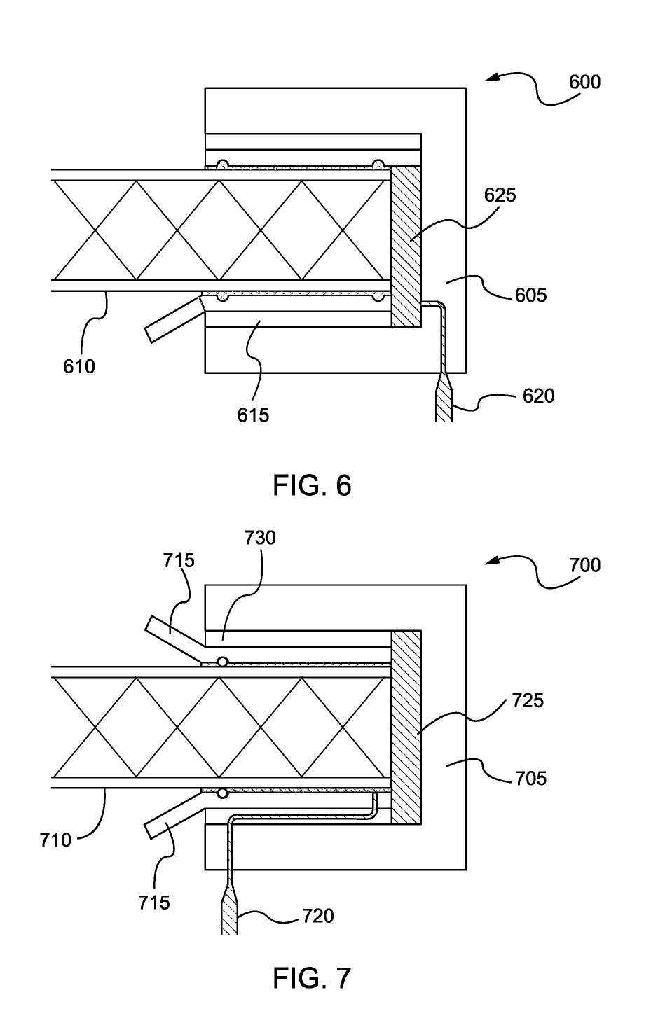

FIG. 6 illustrates an exemplary embodiment of an apparatus 600 having a node having an oversized socket and a co-printed nozzle. In some aspects of the apparatus, the node and nozzle may be printed by additive manufacturing. As shown, the apparatus 600 includes a node 605, a component 610, an injection path 615, and a nozzle 620. The node 605 includes a socket 625. In some aspects of the apparatus, the component 610 is a panel.

As shown, the socket 625 may be substantially larger than a width of a panel 610. The large size of the socket 625 creates greater flexibility in the component size that may be joined with the node 605. Once the component 610 is appropriately situated in the socket 625, an adhesive may be injected through the nozzle 615 and travel through the injection paths 615, which may guide the adhesive to surround the component 610 and hold it in place. Once the adhesive has been successfully injected, the co-printed nozzle 620 may be detached or broken off of the node 605.

FIG. 7 illustrates an exemplary embodiment of an apparatus 700 having a node and co-printed strut. As shown, the apparatus 700 includes a node 705, component 710, struts 715, nozzle 720, and plate 730. The node 705 includes a socket 725.

As shown, the struts 715 may be co-printed with the node 705 and may act to position a free-floating component, such as the component 710 in the socket 725. The struts 715 may work cooperatively with the plate 730 to engage the component 710. The plate 730 may be coupled to the upper and/or lower surfaces of the socket 725 and adjusted in size to accommodate manufacturing variations between the node 705 and component 710.

Once the component 710 is properly positioned, adhesive material may be injected through the injection port 720. In some aspects of the apparatus, the adhesive material is pulled through the socket 725 by a vacuum port and/or forced through the socket by the adhesive port.

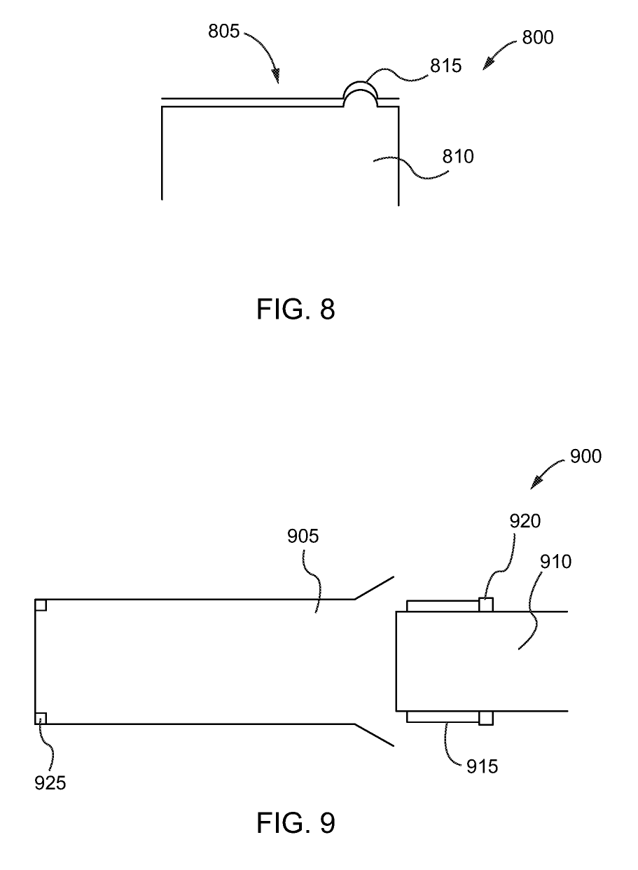

FIG. 8 illustrates an exemplary embodiment of an apparatus 800 having a node 805 and a co-printed notch. In some aspects of the apparatus, the notch serves as a locating feature. As shown, the apparatus 800 includes a node 805, a panel 810 and a projection 815. The projection 815 may be designed to engage a notch in the panel 810 and thereby position the panel 810 in the socket. For instance, the notch on the panel 810 may align with the projection 815 to provide the proper position for the panel within a socket. Once aligned, an adhesive may be applied to fix the node 805 and panel 810. Thus, the projection 815 locates the end portion of the panel in the socket.

FIG. 9 illustrates an exemplary embodiment of an apparatus 900 having a node with co-printed projections. As shown, the apparatus 900 includes a node 905 and a component 910. The node 905 includes locating features 925. The component 910 includes an adhesive 915 and a standoff 920. The component 910 may be a panel and the adhesive 915 may be a tape or film foam adhesive.

In this exemplary drawing, the standoffs 920 may assist with guiding the component 910 into the node 905 until the component 910 reaches the locating features 925. The component 910 may be a panel with opposing surface layers. A pair of standoffs may be positioned on each of the opposing sides of the panel. The panel may have a friction or slip fit with the socket at each of the pair of standoffs.

The locating features 925 may be projections suitable for locating the end portion of the component 910 and guiding the component 910 into place within the node 905. In some aspects of the apparatus, the locating features 925 may be configured to provide a friction or slip fit with an edge of the end portion of the component 910. Once in place, one of the adhesives 915 may be positioned between one of the locators 925 and one of the standoffs 920. The opposing adhesive 915 may be positioned between the opposing standoff 920 and the opposing locating feature 925. Heat may then be applied to the apparatus 900 to cause the adhesive to foam and subsequently cure.

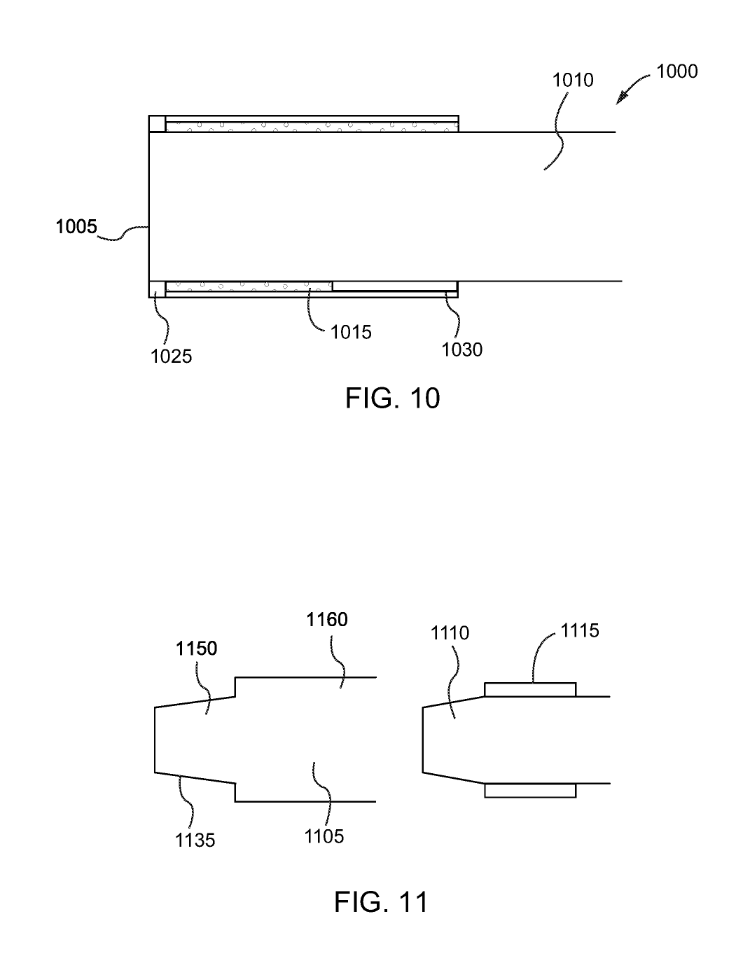

FIG. 10 illustrates an exemplary embodiment of an apparatus 1000 having a node having co-printed projections and secondary shim. The apparatus 1000 includes a node 1005, a component 1010, and a secondary shim 1030. The node 1005 and component 1010 are joined in this exemplary drawing. The node 1005 includes locating features 1025. The panel 1010 includes adhesive 1015.

As shown, the adhesive 1015 is applied internally to the node 1005 after the component 1010 is inserted and located by the locators 1025. In this example, the adhesive 1015 may be an adhesive tape or film foam adhesive. In some aspects of the apparatus, the component 1010 may begin to sag before the adhesive 1015 has finished curing. In such aspects it may be beneficial to use the secondary shim 1030 to prevent sagging in the component during the curing process. Once the node and component are joined, or the adhesive is cured, the secondary shim may be removed. In some aspects of the apparatus, the shim may seal the interface between the node 1005 and the component 1010. In other aspects of the apparatus, a sealant may be applied to the interface between the node 1005 and the component 1010 to intermediately seal the node 1005 to the component 1010 prior to applying and/or curing the adhesive 1015. In such aspects, the adhesive may be a liquid adhesive rather than a film foam or adhesive tape. In some aspects of the apparatus, the liquid adhesive may be injected through the interface between the node 1005 and the component 1010 by elevated injection force or a vacuum force that may pull the adhesive across the interface.

FIG. 11 illustrates an exemplary embodiment of an apparatus having a converging socket locator. FIG. 11 includes a node 1105 having a tapered end 1135 and a component 1110 having an adhesive 1115 applied to opposing sides of the component 1110. Additionally, the node 1105 may have a first gap 1150 and a second gap 1160. In some aspects of the apparatus, the component 1110 is a panel.

In this example, the edges of the component 1110 locate the node 1105. The tapered end 1135 of the node can grab the end of the component 1110 and the adhesive 1115 can fill the outer region of the node/component connection. Such a connection may be a friction or slip fit. In some aspects of the apparatus, the locating features described above may include a first portion of the node socket having a first gap 1150 and a second portion of the socket having a second gap 1160 wider than the first gap 1150. In such aspects, the second gap 1160 may be closer to the socket opening than the first gap 1150 and the first gap 1150 is configured to provide a friction or slip fit with an edge of the end portion of the component 1110.

The co-printed locating features account for manufacturing variations that may occur during additive manufacturing and joining the nodes and components. With the co-printed locating features, nodes may be printed with extra “give” or space that enables the component to move laterally within the node socket while still aligning the component to the proper position within the node.

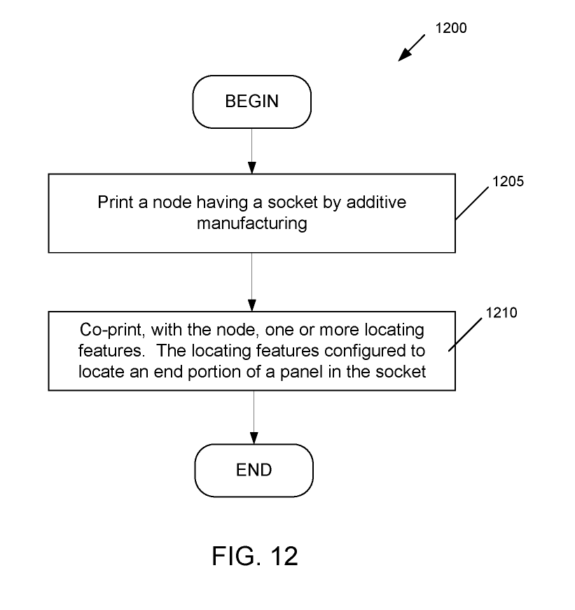

FIG. 12 conceptually illustrates a process 1200 for co-printing a node with locating features. The process 1200 may begin after instructions to print a node with co-printed locating features are provided. As shown, the process 1200 prints (at 1205) a node having a socket by additive manufacturing. The process co-prints (at 1210), with the node, one or more locating features. In some aspects of the process, the locating features are configured to locate an end portion of a panel in the socket. Various aspects of the node and locating features were discussed in greater detail above with respect to FIGS. 1-11.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other techniques for printing nodes and interconnects. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An apparatus, comprising:
an additively manufactured node having a socket; and
one or more locating features co-printed with the node, wherein the one or more locating features are configured to locate an end portion of a component in the socket.

2. The apparatus of claim 1, wherein the one or more locating features are arranged within the socket to maintain a gap between the component and the socket when the component is engaged in the socket.

3. The apparatus of claim 2, wherein the one or more locating features comprise a plurality of deformable barbs.

4. The apparatus of claim 2, wherein the one or more locating features comprise a plurality of bumps.

5. The apparatus of claim 1, wherein the one or more locating features comprise one or more tapered shims.

6. The apparatus of claim 1, wherein the one or more locating features comprise a plate and a plurality of struts coupling the plate to an interior surface of the socket.

7. The apparatus of claim 1, further comprising a detachable additively manufactured nozzle co-printed with the node and arranged for adhesive injection between the component and the socket.

8. The apparatus of claim 1, wherein the socket comprises a projection configured to engage a notch in the component to position the component in the socket.

9. The apparatus of claim 1, wherein the one or more locating features comprises a pair of spaced apart locators positioned on an internal surface of the socket opposite the socket opening, the locators being configured to provide a friction or slip fit with an edge of the end portion of the component.

10. The apparatus of claim 9, wherein the component is positioned in the socket and comprises opposing surface layers and a pair of standoffs, a first one of the standoffs being positioned on a first one of the surface layers on the end portion of the component and a second one of the standoffs being positioned on a second one of the surface layers on the end portion of the component.

11. The apparatus of claim 10, wherein the component has a friction or slip fit with the socket at the first and second standoffs.

12. The apparatus of claim 10, wherein a first portion of the adhesive is applied between a first one of the locators and the first one of the standoffs, and a second portion of the adhesive is applied between a second one of the locators and the second one of the standoffs.

13. The apparatus of claim 1, wherein the one or more locating features comprises a first portion of the socket having a first gap, the socket further comprising a second portion having a second gap wider than the first gap, the second gap being closer to the socket opening than the first gap, and wherein the first gap is configured to provide a friction or slip fit with an edge of the end portion of the component.

14. A method comprising:
printing, by additive manufacturing, a node having a socket;
co-printing with the node, one or more locating features, wherein the one or more locating features are configured to locate an end portion of a component in the socket.

15. The method of claim 14, further comprising:
arranging the one or more locating features within the socket; and
engaging the component in the socket, wherein the one or more locating features maintains a gap between the component and the socket when the component is engaged.

16. The method of claim 15, wherein co-printing the one or more locating features comprises co-printing a plurality of deformable barbs.

17. The method of claim 15, wherein co-printing the one or more locating features comprises co-printing a plurality of bumps.

18. The method of claim 14, wherein co-printing the one or more locating features comprises printing one or more tapered shims.

19. The method of claim 14, wherein co-printing the one or more locating features comprises printing a plate and a plurality of struts, the method further comprising coupling the plate to an interior surface of the socket.

20. The method of claim 14, further comprising:
co-printing an additively manufactured nozzle with the node;
injecting an adhesive between the component and the socket; and
detaching the nozzle from the node.

21. The method of claim 14, further comprising:
co-printing a projection in the socket;
engaging a notch in the component with the projection; and
positioning the component in the socket.

22. The method of claim 14, wherein co-printing the one or more locating features comprises printing a pair of spaced apart locators on an internal surface of the socket opposite the socket opening, and wherein the locators are configured to provide a friction or slip fit with an edge of the end portion of the component.

23. The method of claim 22, further comprising:
positioning a first one of the standoffs on a first one of the surface layers on the end on the end portion of the component;
positioning a second one of the standoffs on a second one of the surface layers on the end portion of the component; and
positioning the component in the socket, the component having opposing surface layers and a pair of standoffs.

24. The method of claim 23, wherein the component has a friction or slip fit with the socket at the first and second standoffs.

25. The method of claim 23, further comprising:
applying a first portion of the adhesive between a first one of the locators and the first one of the standoffs; and
applying a second portion of the adhesive to a second one of the locators and the second one of the standoffs.

26. The method of claim 22, further comprising, before positioning the component in the socket:
applying a first adhesive strip to a first side of the component;
applying a second adhesive strip to a second side of the component; and
positioning the component in the socket, the component having opposing surface layers, wherein the first and second adhesive strips are applied to the opposing surface layers.

27. The method of claim 26, further comprising inserting a shim between the component and the node prior to curing the first and second adhesive strips, the shim for preventing the component from sagging before the adhesive strips cure.

28. The method of claim 26, wherein the first and second adhesive strips are film foam adhesives.

29. The method of claim 22, further comprising:
positioning the component in the socket to form an interface between the component and the socket;
inserting a shim to seal the interface; and
injecting a liquid adhesive through the interface by elevated injection force.

30. The method of claim 22, further comprising:
positioning the component in the socket to form an interface between the component and the socket;
inserting a shim to seal the interface;
applying a sealant to the interface; and
injecting a liquid adhesive through an injection port to the interface, wherein a vacuum force pulls the adhesive through the interface to a vacuum port.

31. The method of claim 14, wherein the one or more locating features comprises a first portion of the socket having a first gap, the socket further comprising a second portion having a second gap wider than the first gap, the second gap being closer to the socket opening than the first gap, and wherein the first gap is configured to provide a friction or slip fit with an edge of the end portion of the component.
